(19) United States
(12) Patent Application Publication
(10) Pub. No.: US 2024/0280136 A1
(43) Pub. Date: Aug. 22, 2024

(54) BALL JOINT

(71) Applicant: ILJIN Co., Ltd., Gyeongju-si Gyeongsangbuk-do (KR)

(72) Inventors: Nam Deok HAN, Seoul (KR); Jun Yong SEO, Seoul (KR); Yoon Geon LEE, Gyeongju-si Gyeongsangbuk-do (KR); Chul Soon IM, Yeoju-si Gyeonggi-do (KR); Sang Oh PARK, Gyeongju-si Gyeongsangbuk-do (KR)

(73) Assignee: ILJIN Co., Ltd., Gyeongju-si Gyeongsangbuk-do (KR)

(21) Appl. No.: 18/442,186

(22) Filed: Feb. 15, 2024

(30) Foreign Application Priority Data
Feb. 22, 2023 (KR) 10-2023-0023287

(51) Int. Cl. F16C 11/06

(52) U.S. Cl. CPC F16C 11/0671

(57) ABSTRACT

The present disclosure provides a ball joint including: a ball stud having a ball portion of a spherical shape formed partially in a longitudinal direction of the ball stud; a bearing configured to surround the ball portion of the ball stud while being in a slidable contact with the ball portion; a cylindrical casing into which the ball stud and the bearing are inserted; a dust cover configured to seal an opening of the casing; and a caulking portion formed inward of the casing to fix the bearing. In the ball joint, the caulking portion is formed inward of the casing to axially fix the bearing, which increases a contact area on which the casing is brought into contact with other part, ensures a stable fixation, improves a degree of freedom in design while maintaining the layout as it is.

### CROSS-REFERENCE TO RELATED APPLICATIONS

This application claims priority to Korean Patent Application No. 10-2023-0023287, filed on Feb. 22, 2023, the entire contents of which are herein incorporated by reference.

### TECHNICAL FIELD

The present disclosure relates to a balljoint, and more particularly, to an improved ball joint in which a caulking portion for axially fixing a bearing is formed inward of a casing to increase a contact area on which the casing is in contact with other part, ensure a stable fixation of the other part to the casing, improve a degree of freedom in design of a dust cover while maintaining a layout.

### BACKGROUND

A rubber bushing or ball joint may be applied as a joint part installed in a suspension and a steering device of a vehicle. In particular, a cross axis ball joint may be applied to a high-class vehicle.

Such a ball joint includes a ball stud which serves as a spheroid joint, a bearing which surrounds the ball stud to protect the ball stud and controls a friction force acting between the ball stud and a casing, the casing in which the ball stud and the bearing are incorporated, a ball seat which seals the ball stud to prevent the ball stud from being separated from an opening of the casing due to a tensile load, and a dust cover which closes the opening of the casing to prevent dust from being introduced into the ball seat and the ball stud. Normally, the ball joint is assembled with a knuckle or the like as other part.

In this case, as illustrated in FIGS. 1 and 2, in order to fix the bearing and the ball seat, a method which includes applying an axial load to a portion of an outer circumferential surface of the casing for caulking, or fastening a snap ring into the casing as sited in the Document in Related Art below, is employed.

In the case where the portion of the outer circumferential surface of the casing is caulked, a contact area A on which the casing may be brought into contact with the other part may be reduced by such a caulked portion.

In addition, a design layout of a fixing portion for fixing a ball seat 20 a mounting portion for mounting a dust cover 30 may be limited, which causes difficulty in design.

In general, cold forging is used to process a ball stud 40 for mounting the dust cover 30. This takes a lot of time and makes it difficult to implement a protruded portion for mounting.

In addition, in the case where the contact area on which the casing 10 is brought into contact with the other part is reduced, it may be difficult to increase a thickness of the other part.

In addition, since the caulking portion is formed to axially press one end of the outer circumferential surface of the casing 10, the ball seat 20 is located higher than an end portion of the casing 10. This increases the size of the dust cover 30 for covering the ball seat 20, which results in an increase in length of the ball stud 40. As a result, an unstable structure and unnecessary costs may be caused.

The present disclosure provides a ball joint capable of solving such matters in the related art. The ball joint to which the present disclosure is directed may be applied to both a case in which the caulking portion is formed only in one of both ends of the ball stud 40 and a case in which the caulking portion is formed in both ends of the ball stud 40.

### DOCUMENT IN RELATED ART

### Patent Documents

Patent Document 1: U.S. Pat. No. 5,284,398 (filed on Feb. 8, 1994, entitled “Pillow joint ball and method of making the joint”)
Patent Document 2: European Patent No. 1010904 (filed on Jun. 21, 2000, entitled “Ball joint”

### SUMMARY

The present disclosure was made to solve the above-mentioned matters in the related art, and the present disclosure is for the purpose of providing a ball joint having an improved configuration in which a caulking portion is formed inward of a casing to axially fix a bearing, thus increasing a contact area on which the casing is brought into contact with other part, ensuring a stable fixation, improving a degree of freedom in design while maintaining a layout as it is.

One aspect of the present disclosure provides a ball joint including: a ball stud 100 having a ball portion 102 of a spherical shape formed partially in a longitudinal direction of the ball stud 100; a bearing 200 configured to surround the ball portion 102 of the ball stud 100 while being in a slidable contact with the ball portion 102; a cylindrical casing 300 into which the ball stud 100 and the bearing 200 are inserted; a ball seat 400 configured to fix the bearing 200 so as to prevent the bearing 200 from being separated from the casing 300; a dust cover 500 configured to seal an opening of the casing; and a caulking portion formed inward of the casing 300 to fix the bearing 200.

In an example embodiment, the ball joint may further include a ball seat 400 provided above the bearing 200 to fix the bearing 200.

In an example embodiment, the dust cover 500 may further include a sealing portion 530 of a clamp shape provided on a periphery of the dust cover 500.

In an example embodiment, the dust cover 500 may further include an elastically-deformable groove 520 formed in a periphery of the dust cover 500.

In an example embodiment, the caulking portion may be a protruded portion 310 formed to extend toward a center of the casing 300 from an inner circumferential surface of the casing 300.

In an example embodiment, the ball stud may include a rod 104 formed to extend in a longitudinal direction of the ball stud 100 from each of upper and lower ends of the ball portion 102 which is formed partially in the longitudinal direction of the ball stud 100.

In an example embodiment, the ball stud may have a vertically-perforated hollow interior, and a ball-like depressed portion 106 may be formed in the interior to correspond to a shape of the ball portion 102.

In an example embodiment, a sealing portion 530 of a clamp shape may be formed on a periphery of the dust cover 500 so as to be in an elastic close contact with an inner circumferential surface of the casing 300 at openings of both ends openings of the casing 300.

In an example embodiment, the casing 300 may be further extended in the longitudinal direction from the caulking portion.

In an example embodiment, one end of the dust cover 500 may be in contact with an inner circumferential surface of the opening of the casing 300.

Further, another aspect of the present disclosure provides a ball joint including: a ball stud 100 having a ball portion 102 of a spherical shape formed partially in a longitudinal direction of the ball stud 100; a bearing 200 configured to surround the ball portion 102 of the ball stud 100 while being in a slidable contact with the ball portion 102; a cylindrical casing 300 into which the ball stud 100 and the bearing 200 are inserted; a dust cover 500 configured to seal an opening of the casing; and a caulking portion formed inward of the casing 300 to fix the bearing 200.

In an example embodiment, the caulking portion may be formed inward of the casing 300 to prevent the bearing 200 from being separated from the ball stud 100, and may be a protruded portion formed to extend toward a center of the casing 300 from the inner circumferential surface of the casing 300.

In an example embodiment, an elastically-deformable groove 520 may be formed on the periphery of the dust cover 500, and a sealing portion 530, which is an outer shell of the elastically-deformable groove 520, may be brought into elastic contact with inner circumference surfaces of the openings at both ends of the case 300.

In an example embodiment, an elastically-deformable groove may be further formed in an upper surface of the bearing 200.

In an example embodiment, a plurality of convex-concave grooves 510 may be formed in the dust cover 500.

According to an example embodiment of the present disclosure, by caulking a caulking portion inward of a casing, it is possible to increase a contact area on which the casing is brought into contact with other part while maintaining an existing layout as it is.

Further, according to an example embodiment of the present disclosure, by satisfying customer needs to secure product competitiveness and replacing an existing bushing with a ball joint, it is possible to expand the market for the ball joint.

Further, according to an example embodiment of the present disclosure, by providing the caulking portion inward of the casing, it is possible to increase a degree of freedom in design layout of a site in which a dust cover is mounted.

Further, according to an example embodiment of the present disclosure, by increasing the contact area on which the casing is brought into contact with the other part, it is possible to maintain a thickness of the other part.

Further, according to an example embodiment of the present disclosure, it is possible to improve the appearance of the ball joint.

### BRIEF DESCRIPTION OF THE DRAWINGS

FIG. 1 is an illustration illustrating a structure of a ball joint in the related art in which a caulking portion is provided outside a casing.

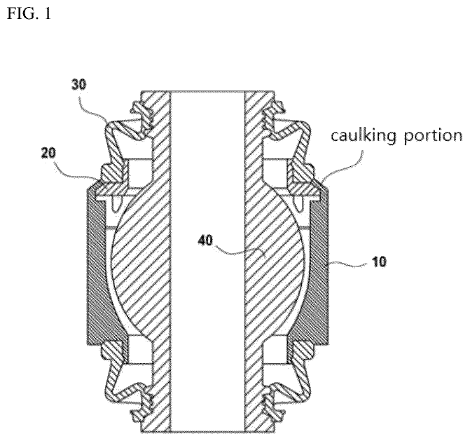

FIG. 2 is an exemplary cutaway cross-sectional view illustrating main constituent elements in FIG. 1.

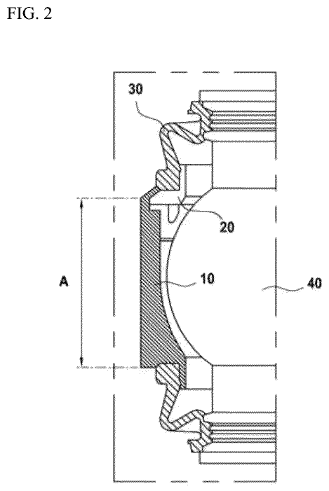

FIG. 3 is an exemplary external perspective view of a ball joint according to an example embodiment of the present disclosure.

FIG. 4 is an exemplary cross-sectional view of the ball joint according to a first example embodiment of the present disclosure.

FIG. 5 is an exemplary cutaway cross-sectional view illustrating main constituent elements in FIG. 4.

FIG. 6 is an exemplary cross-sectional view of a ball joint according to a second example embodiment of the present disclosure.

FIG. 7 is an exemplary partially-cutaway perspective view illustrating a longitudinal cross-section of a portion of FIG. 6.

FIG. 8 is an exemplary exploded cross-sectional view illustrating constituent elements in FIG. 6.

FIG. 9 is a photograph illustrating an exemplary cross-section of a sample of a ball joint according to an example embodiment of the present disclosure.

FIG. 10 illustrates the results of a simulation conducted to check an anti-separation property of the ball stud and confirm the applicability of the ball joint according to an example embodiment of the present disclosure.

FIG. 11 shows that the ball joint according to an example embodiment of the present disclosure has a significantly expanded contact area on which other part is brought into contact with the casing compared to that in the related art.

### DETAILED DESCRIPTION

Hereinafter, preferred example embodiments of the present disclosure will be described in more detail with reference to the accompanying drawings.

Before the description of the present disclosure, the following specific structure and functional descriptions are merely illustrated for the purpose of describing an example embodiment according to the concept of the present disclosure, and the example embodiments according to the concept of the present disclosure may be embodied in various forms and are not to be construed as limited to the example embodiments described herein.

In addition, the example embodiments according to the concept of the present disclosure may be varied in various forms, and specific example embodiments are illustrated in the drawings and will be described in detail. However, the example embodiments according to the concept of the present disclosure are not limited to such specific disclosures, and may include all modifications, equivalents, and alternatives falling within the spirit and scope of the present disclosure.

Expressions in the singular form should be understood to encompass expressions in the plural form unless the context clearly indicates otherwise. The term “includes”, “has” or the like are intended to include features, numeric characters, processes, operations, constituent elements, parts, or a combination thereof, and should be understood not to exclude one or more other features, numeric characters, processes, operations, constituent elements, parts, or a combination thereof, or additional features and the like. In particular, reference numerals used herein are merely provided to help more general understanding of the present disclosure, and the present disclosure is not limited to the above example embodiments.

The expression such as “at least one” encompass the entire list of components and does not individually represent respective constituent elements in the list. For example, the expression “at least one of A, B, and C” may include the following meanings: “A alone”, “B alone”, “C alone”, “both A and B together”, “both A and C together”, “both B and C together”, or “all three of A, B, and C together”.

Further, although the terms including ordinal numbers such as a first, a second and the like used herein may be used to describe various constituent elements, such constituent elements should not be limited by terms including the ordinal numbers. The above terms may be used to distinguish a constituent element from another constituent element in a description of the specification in context. For example, a first constituent element may be named as a second constituent element in another description of the specification without departing from the scope of the present disclosure. Conversely, the second constituent element may be named as the first constituent element in another description of the specification. The expression “and/or” includes a combination of a plurality of related items or any one of a plurality of related items.

### First Example Embodiment

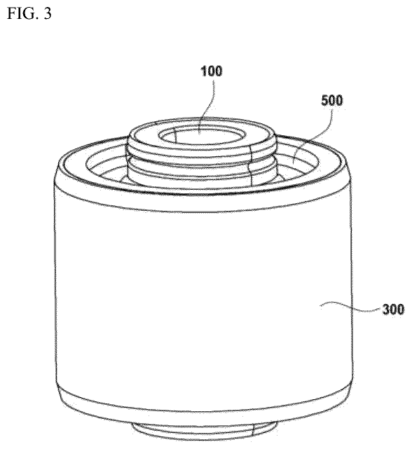

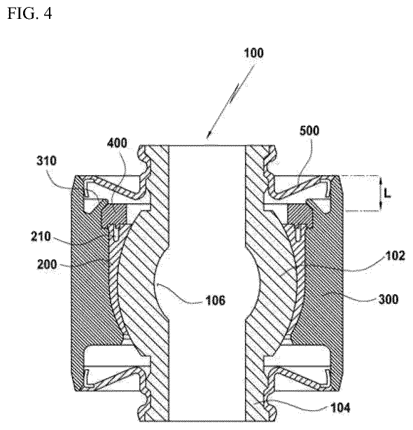

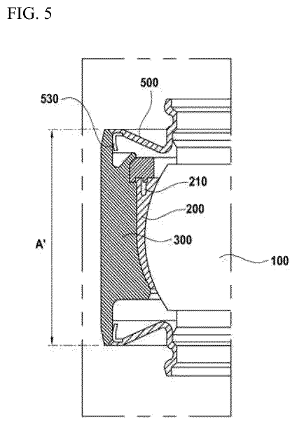

FIG. 3 is an exemplary external perspective view of a ball joint according to an example embodiment of the present disclosure. FIG. 4 is an exemplary cross-sectional view of a ball joint according to a first example embodiment of the present disclosure. FIG. 5 is an exemplary cutaway cross-sectional view illustrating main constituent elements in FIG. 4.

Referring to FIGS. 3 to 5, the ball joint may include a ball stud 100 which serves as a spheroid joint, a bearing 200 which surrounds the ball stud 100 to protect the ball stud 100 and controls a friction force, a cylindrical casing 300 in which the ball stud 100 and the bearing 200 are incorporated, a ball seat 400 which seals the ball stud 100 so that the ball stud 100 is not separated from upper and lower openings of the casing 300 due to a tensile load, and a dust cover 500 which closes the upper and lower openings of the casing 300 to prevent dust from being introduced into the ball seat 400 and the ball stud 100.

In the case, the ball stud 100 may have a spherical ball portion 102 formed partially in a longitudinal direction of the ball stud 100, and may have a structure in which a rod 104 is formed to extend outward from upper and lower ends of the ball portion 102.

The ball stud 100 configured as above may be preferably processed by cold forging.

Further, the ball stud 100 may have a vertically-perforated hollow interior. In particular, the ball stud 100 may have a ball-like depressed portion 106 formed to correspond to a portion in which the ball portion 102 is formed. This reduces the weight of the ball stud 100 and increases a force of suppressing the ball stud 100 from being distorted or deformed due to an external force.

In addition, the bearing 200 may be assembled so as to surround the ball portion 102 of the ball stud 100 in a slidable contact with the ball portion 102.

Preferably, the bearing 200 may be made of plastics, specifically, a continuous fiber reinforced thermoplastics (CFRTPC). More preferably, from the viewpoint of enhancing lubricity and durability, the bearing 200 may be made of aramid CFRTPC in which aramid is composited.

Further, as illustrated in FIGS. 4 and 5, an elastically-deformable groove 210 may be formed to be depressed locally downward in an upper surface of the bearing 200. The elastically-deformable groove 210 functions such that the bearing 200 is easily inserted between the ball stud 100 and the casing 300 during the installation of the bearing 200, the bearing 200 is in a further close contact with the ball stud 100 and the casing 300 by virtue of a restoring force after the insertion, and the bearing 200 is coupled with the ball seat 400.

Further, the casing 300 may be formed in a cylindrical shape having openings at both ends thereof.

The casing 300 may be manufactured by press-machining or drawing with a metallic material to ensure rigidity.

In addition, a protruded portion 310 may be formed on the inner circumferential surface of one end of the openings of the casing 300.

The protruded portion 310 may be formed to extend toward the center of the casing 300 from the inner circumferential surface of the casing 300.

Further, the protruded portion 310 may be depressed inward of the casing 300 at the opening during assembly of the ball joint to partially surround the ball seat 400, and may be caulked to prevent the ball seat 400 from being separated through the opening.

That is, the protruded portion 310 is pressed in a longitudinal direction of the casing 300 to caulk the ball seat 400.

In this case, the casing 300 may be further extended in the longitudinal direction by a certain amount, e.g., L in FIG. 4 from the protruded portion 310 as a caulking portion.

In addition, since the periphery of the casing 300 is not caulked, a contact area A on which the casing 300 is assembled with other part, may be relatively increased compared to a case in the related art.

That is, since a portion, which has been folded for caulking in the related art, is spread, the contact area A′ is expanded by such a spread magnitude.

As described above, the protruded portion 310 is formed such that such a caulked portion is formed inward of the casing 300. This makes it possible to significantly increase the contact area A′ on which the casing 300 is assembled with the other part while the ball seat 400 is located as it is.

In other words, it is possible to easily solve the matters in the related art without significantly changing the layout.

In the related art, one end of the casing is caulked and folded. However, in an example embodiment of the present disclosure, one end of the casing 300 is not caulked but is in an unfolded state. This makes it possible to provide a relatively further extended portion L.

Thus, in the first example embodiment of the present disclosure, one end of the dust cover 500 may be contacted with an inner surface of the opening of the casing 300. This improves the appearance of the ball joint.

This holds true with respect to the dust cover which is assembled with the other end of the casing 300.

Further, a stable assembling structure of the dust cover 500 may be ensured by an assembling structure described as above. Accordingly, the length of the ball stud 100 may be relatively shortened compared to the case in the related art merely by changing the shape of the ball seat 400

Further, the sealing portion 530 of a clamp shape as illustrated in FIG. 5 are formed on a periphery of the dust cover 500 so as to be in an elastic close contact with inner peripheral surfaces of the opening at both ends of the casing 300. This further increases a sealing property, which makes it possible to completely block the introduction of the dust into the ball stud.

### Second Example Embodiment

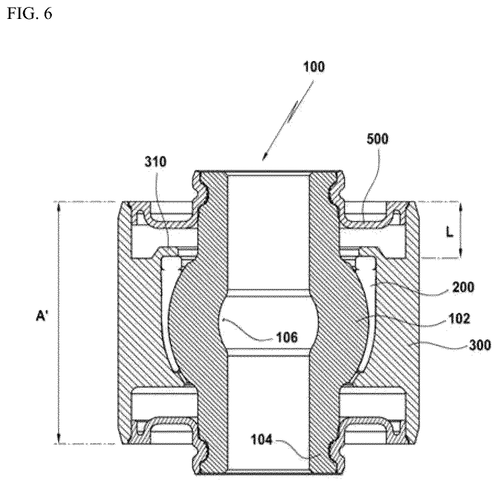

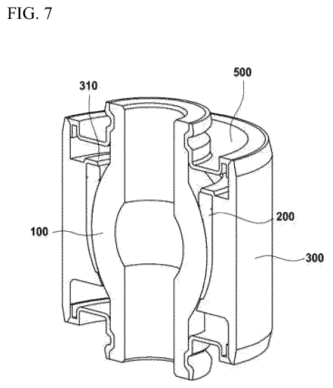

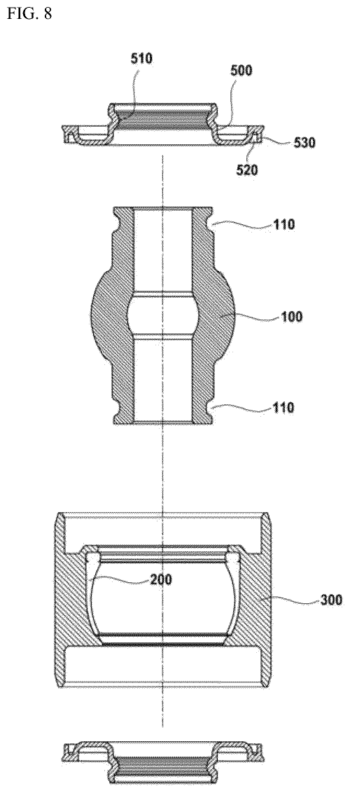

FIG. 6 is an exemplary cross-sectional view of a ball joint according to a second example embodiment of the present disclosure. FIG. 7 is an exemplary partially-cutaway perspective view illustrating a longitudinal cross-section of a portion of FIG. 6. FIG. 8 is an exemplary exploded cross-sectional view illustrating constituent elements in FIG. 6.

Referring to FIGS. 6 to 8, the ball joint according to the second example embodiment of the present disclosure may include a ball stud 100 which serves as a spheroid joint, a bearing 200 which surrounds the ball stud 100 to protect the ball stud 100 and controls a friction force, a cylindrical casing 300 in which the ball stud 100 and the bearing 200 are incorporated, and a dust cover 500 which closes upper and lower opening portions of the casing 300 to prevent dust from being introduced into the ball stud 100.

In this case, the casing 300 may have the same structure as that in in the above-described first example embodiment. That is, the ball joint may include the protruded portion 310 functioning as a caulking portion.

Unlike the above-described first example embodiment, the ball joint according the second example embodiment of the present disclosure does not include the ball seat 400 (see FIG. 4). This provides a relatively simple structure and further increases a degree of freedom in design layout.

That is, the design is relatively easy and the assembly is also relatively simple and easy.

In other words, the ball stud 100 may have a spherical ball portion 102 formed partially in a longitudinal direction, and may have a structure in which a rod 104 is formed to extend outward from upper and lower ends of the ball portion 102.

The ball stud 100 configured as above may be preferably processed by cold forging.

Further, the ball stud 100 may have a vertically-perforated hollow shape. In particular, the ball stud 100 may have a ball-like depressed portion 106 formed to correspond to a portion in which the ball portion 102 is formed. This reduces the weight of the ball stud 100 and increases a force of suppressing the ball stud 100 from being distorted or deformed due to an external force.

In addition, the bearing 200 may be assembled so as to surround the ball portion 102 of the ball stud 100 in a slidable contact with the ball portion 102.

Preferably, the bearing 200 may be made of plastics, specifically, a continuous fiber reinforced thermoplastics (CFRTPC). More preferably, the bearing 200 may be made of aramid CFRTPC in which aramid is composited from the viewpoint of enhancing lubricity and durability.

Further, the casing 300 may be formed in a cylindrical shape having openings at both ends thereof.

The casing 300 may be manufactured by press-machining or drawing with a metallic material to ensure rigidity.

In addition, a protruded portion 310 may be formed on the inner circumferential surface of one end of the openings of the casing 300.

The protruded portion 310 may be formed to extend toward the center of the casing 300 from the inner circumferential surface of the casing 300.

Further, the protruded portion 310 may be depressed inward of the casing 300 at the opening during assembly of the ball joint to partially surround the bearing 200, so that the bearing 200 may be caulked so as not to be separated through the opening.

That is, the protruded portion 310 is pressed in a longitudinal direction of the casing 300 to caulk the bearing 200.

In this case, the casing 300 may be further extended in the longitudinal direction by a certain amount, e.g., L in FIG. 6 from the protruded portion 310 as a caulking portion.

Further, the protruded portion 310 may be pressed for caulking, and may be fixed to prevent the separation of the bearing 200 as in the first example embodiment.

In particular, since the ball seat is not provided, a space may be reduced by a thickness of the ball seat, which makes it possible to reduce the length of the ball stud 100 by the space.

Further, in the second example embodiment of the present disclosure, no protrusion is formed on circumferences of both ends of the ball stud 100 and locking grooves 110 are formed instead of the protrusion. This facilitates the forgoing process.

Alternatively, in order to ensure a stable fixation of the dust cover 500 and increase a sealing property thereof, a plurality of convex-concave grooves 510 having a mechanical sealing shape may be formed in portions of the dust cover 500, which correspond to the locking grooves 110.

In addition, as illustrated of FIG. 8, elastically-deformable grooves 520 may be formed in the circumference of the dust cover 500 so that sealing portions 530, which are outer shells of the elastically-deformable grooves 520, are brought into elastic close contact with the inner circumferential surfaces of the opening at both ends of the casing 300. This makes it possible to further increase the sealing property and sufficiently block the introduction of the dust.

With this configuration, it is possible to further expand the contact area and increase the adhesion force, which improves the sealing property. Thus, the dust cover 500 is hard to be separated from the ball stud 100.

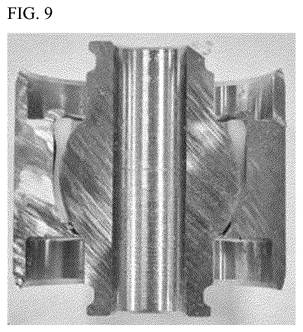

The actual structure of the ball joint according to the example embodiment of the present disclosure is illustrated in FIG. 9.

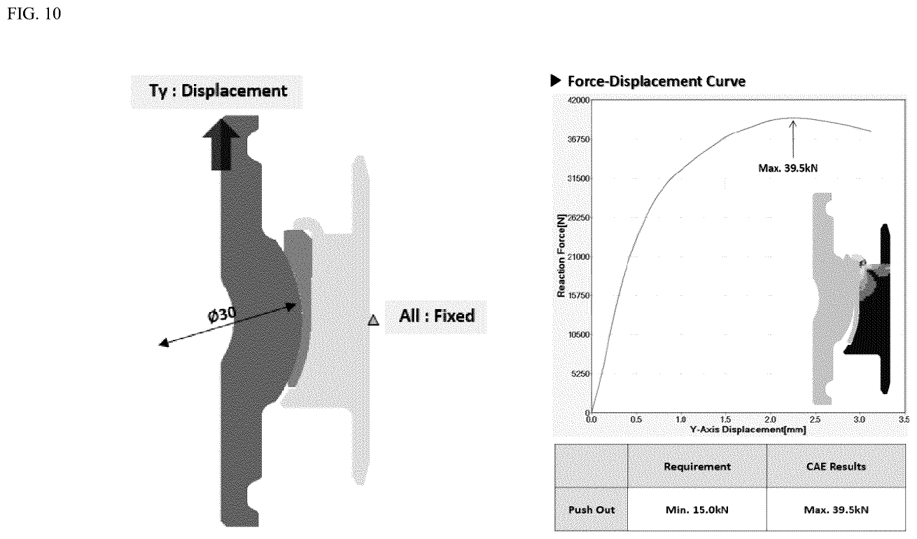

A simulation was conducted to check an anti-separation property of the ball stud and confirm the applicability of the ball joint according to the above-described example embodiments of the present disclosure. The graph in FIG. 10 illustrates the results of the simulation.

In this simulation, a load is applied in an axial direction of the ball stud in a state in which the casing is completely fixed to the ball stud having a diameter of 30 mm and a degree of displacement was checked.

In this case, as required specifications, the displacement is required to be maintained until a minimum load of 15 kN is applied. However, as illustrated in the above graph, the simulation results show that the displacement occurs up to 2.25 mm at maximum until the load of 39.5 kN is applied while gradually increasing the load, whereas no displacement occurs when the load of 39.5 kN or more is applied and the separation of the ball stud is also not generated. Thus, the simulation results show that the anti-separation property is significantly improved compared to the required specifications.

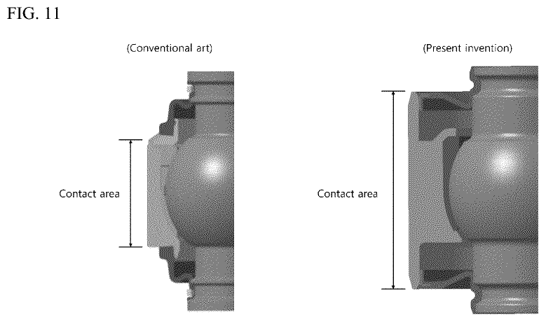

In particular, the graph in FIG. 11 visually shows that the ball joint according to the example embodiments of the present disclosure has a significantly expanded contact area on which other part is brought into contact with the casing compared to that in the related art.

That is, in a case where the caulking portion is formed outside the casing, the contact area on which the other part is brought into contact with the casing may be decreased by the size of the caulking portion. However, according to the example embodiments of the present disclosure, by forming the caulking portion inward of the casing, it is possible to further expand the contact area by the size of the caulking portion.

### EXPLANATION OF REFERENCE NUMERALS

100: Ball stud
200: Bearing
300: Casing
400: Ball seat
500: Dust cover

What is claimed is:

1. A ball joint comprises:
a ball stud having a ball portion of a spherical shape formed partially in a longitudinal direction of the ball stud;
a bearing configured to surround the ball portion of the ball stud while being in a slidable contact with the ball portion;
a cylindrical casing into which the ball stud and the bearing are inserted;
a dust cover configured to seal an opening of the casing; and
a caulking portion formed inward of the casing to fix the bearing.

2. The ball joint of claim 1, further comprising: a ball seat provided above the bearing to fix the bearing.

3. The ball joint of claim 1, wherein the dust cover further comprises a sealing portion of a clamp shape provided on a periphery of the dust cover.

4. The ball joint of claim 1, wherein the dust cover further has an elastically-deformable groove formed in a periphery of the dust cover.

5. The ball joint of claim 1, wherein the caulking portion is a protruded portion formed to extend toward a center of the casing from an inner circumferential surface of the casing.

6. The ball joint of claim 1, wherein the ball stud has a rod formed to extend in a longitudinal direction of the ball stud from each of upper and lower ends of the ball portion which is formed partially in the longitudinal direction of the ball stud.

7. The ball joint of claim 6, wherein the ball stud has a vertically-perforated hollow interior, and
wherein a ball-like depressed portion is formed in the interior to correspond to a shape of the ball portion.

8. The ball joint of claim 1, wherein the casing is further extended in the longitudinal direction from the caulking portion.

9. The ball joint of claim 1, wherein one end of the dust cover is in contact with an inner circumferential surface of the opening of the casing.

10. The ball joint of claim 8, wherein the caulking portion is formed inward of the casing to prevent the bearing from being separated from the ball stud, and is a protruded portion formed to extend toward a center of the casing from an inner circumferential surface of the casing.

11. The ball joint of claim 1, wherein an elastically-deformable groove is further formed in an upper surface of the bearing.

12. The ball joint of claim 1, wherein a plurality of convex-concave grooves are formed in the dust cover.
